(19) United States
(12) Patent Application Publication
(10) Pub. No.: US 2024/0078504 A1
(43) Pub. Date: Mar. 7, 2024

(54) CAPACITY-CONSTRAINED CLUSTERING OF DELIVERIES USING VARIABLE-CAPACITY DELIVERY MECHANISMS

(71) Applicant: Target Brands, Inc., Minneapolis, MN (US)

(72) Inventors: MEHMET DULMAN, Minneapolis, MN (US); LUTFI UCAR, San Francisco, CA (US)

(73) Assignee: Target Brands, Inc., Minneapolis, MN (US)

(21) Appl. No.: 17/901,612

(22) Filed: Sep. 1, 2022

(51) Int. Cl. G06Q 10/08

(52) U.S. Cl. CPC G06Q 10/08355

(57) ABSTRACT

A clustering and routing platform that applies capacity constraints at individualized routes as part of the process of clustering deliveries into groups is provided. In particular, vehicle capacity, route length, route efficiency/timing, and various other constraints may be used as part of the clustering process to better group delivery locations into routes.

### BACKGROUND

Retail organizations are increasingly electing to deliver goods directly to customers at their homes and places of business. This “last mile” delivery process can include deliveries from warehouses, or in some circumstances, deliveries from stores or other downstream locations within a retail supply chain.

In this context, such retail organizations seek to provide fast service to customers, and therefore strive to provide same-day or next-day delivery services by receiving delivery orders, identifying locations from which those delivery orders may be fulfilled which are close to the delivery address for the order, and then assigning those delivery orders to a particular carrier for delivery. In some contexts, the carrier may be a crowdsourced delivery services using a plurality of different carriers or delivery persons who may use different sized vehicles, and who may have different delivery schedule availabilities.

Existing software solutions for assisting with assigning deliveries to particular carriers typically involve designing routes on the assumption of a particular number of stops that may be performed by a delivery carrier, or based on a constant capacity delivery vehicle. Such solutions add simplicity to the carrier assignment process and are particularly useful in high-capacity delivery environments that utilize a large number of delivery vehicles, locations, and routes. However, these solutions lack efficiency or are otherwise limited by assumptions made when generating routing solutions. For example, carrier routes are selected based on an assumption that each vehicle or delivery mechanism that is eligible to fulfill a route is equivalent. However, due to differing vehicle sizes, fuel efficiencies, and the like, a routing solution may associate deliveries with a vehicle that are larger or smaller than that vehicle's actual carrying capacity, or which may require a particularly fuel inefficient vehicle to make many stops along a route. Furthermore, existing automated routing software solutions merely generate an end state representative of a set of routes and delivery assignments, without insight as to how such routing solutions are developed to a user of the software. As such, improvements in generating carrier routing solutions within the context of a last mile delivery solution are desirable.

### SUMMARY

In general, the present disclosure is directed to a clustering and routing platform that applies capacity constraints at individualized routes as part of the process of clustering deliveries into groups. In particular, vehicle capacity, route length, route efficiency/timing, and various other constraints may be used as part of the clustering process to better group delivery locations into routes. Such application of capacity constraints improves the overall routing solution by better utilizing available vehicle capacity and improving the cost minimization for delivery routes. The application of capacity constraints at the time of cluster creation also reduces the need for iteration through suboptimal routing solutions, and reduces the need for ad-hoc modifications to route definitions as might be created using unconstrained clustering processes.

In a first aspect, a method of generating a routing solution for last-mile deliveries of items to customers is provided. The method includes receiving, at a computing system, order information regarding a plurality of orders of items for delivery to different delivery locations within a geographical area. The method also includes receiving, at the computing system, an identification of a plurality of vehicles eligible to perform deliveries within the geographical area within a predetermined delivery time period. The method further includes assigning, at the computing system, a maximum route length and a maximum delivery capacity to each of the plurality of vehicles, wherein the maximum delivery capacity varies among the plurality of vehicles. The method also includes, based on a determined size of each of the plurality of orders, the different delivery locations, the maximum route length, and the maximum delivery capacity of each of the plurality of vehicles, performing, at the computing system, a clustering algorithm on the plurality of orders to generate a plurality of clusters, each cluster being associated with a different, particular vehicle of the plurality of vehicles and including a plurality of delivery locations that are associated with one of the plurality of orders. The method additionally includes, for each cluster, generating a route among the plurality of delivery locations assigned to the cluster, the route being assigned to the particular vehicle such that the orders associated with the plurality of delivery locations do not exceed the maximum delivery capacity of the particular vehicle and the route has a length less than the maximum route length.

In a second aspect, a delivery routing system is described. The delivery routing system is implemented on at least one computing device, and includes a processor and a memory storing computer-executable instructions. When executed, the instructions cause the delivery routing system to perform: receiving, at a computing system, order information regarding a plurality of orders of items for delivery to different delivery locations within a geographical area; receiving, at the computing system, an identification of a plurality of vehicles eligible to perform deliveries within the geographical area within a predetermined delivery time period; assigning, at the computing system, a maximum route length and a maximum delivery capacity to each of the plurality of vehicles, wherein the maximum delivery capacity varies among the plurality of vehicles; based on a determined size of each of the plurality of orders, the different delivery locations, the maximum route length, and the maximum delivery capacity of each of the plurality of vehicles, performing, at the computing system, a clustering algorithm on the plurality of orders to generate a plurality of clusters, each cluster being associated with a different, particular vehicle of the plurality of vehicles and including a plurality of delivery locations that are associated with one of the plurality of orders; and for each cluster, generating a route among the plurality of delivery locations assigned to the cluster, the route being assigned to the particular vehicle such that the orders associated with the plurality of delivery locations do not exceed the maximum delivery capacity of the particular vehicle and the route has a length less than the maximum route length.

In a third aspect, a computer storage medium is disclosed that stores computer-executable instructions thereon. When executed by a computing system including a processor and a memory, the instructions cause the computing system to perform a method of generating a routing solution for last-mile deliveries of items to customers. The method includes receiving, at a computing system, order information regarding a plurality of orders of items for delivery to different delivery locations within a geographical area. The method also includes receiving, at the computing system, an identification of a plurality of vehicles eligible to perform deliveries within the geographical area within a predetermined delivery time period. The method further includes assigning, at the computing system, a maximum route length and a maximum delivery capacity to each of the plurality of vehicles, wherein the maximum delivery capacity varies among the plurality of vehicles. The method also includes, based on a determined size of each of the plurality of orders, the different delivery locations, the maximum route length, and the maximum delivery capacity of each of the plurality of vehicles, performing, at the computing system, a clustering algorithm on the plurality of orders to generate a plurality of clusters, each cluster being associated with a different, particular vehicle of the plurality of vehicles and including a plurality of delivery locations that are associated with one of the plurality of orders. The method additionally includes, for each cluster, generating a route among the plurality of delivery locations assigned to the cluster, the route being assigned to the particular vehicle such that the orders associated with the plurality of delivery locations do not exceed the maximum delivery capacity of the particular vehicle and the route has a length less than the maximum route length.

### BRIEF DESCRIPTION OF THE DRAWINGS

The same number represents the same element or same type of element in all drawings.

FIG. 1 is an example of a last mile delivery environment in which aspects of the present disclosure may be implemented.

FIG. 2 is an example block diagram of a system for performing clustering of deliveries in a capacity-constrained environment having variable-capacity delivery mechanisms.

FIG. 3 is a flowchart of a method of performing clustering and deployment of delivery routes in a last mile delivery environment, according to an example embodiment.

FIG. 4 is a flowchart of a method of performing a capacity-constrained clustering process within the method of FIG. 3, according to one example implementation.

FIG. 5 is a flowchart of a method of generating candidate clusters, in an example implementation.

FIG. 6 is a logical diagram of a minimum cost flow portion of a clustering algorithm used in conjunction with aspects of the present disclosure.

FIG. 7 is an example user interface depicting an example set of clusters associated with a plurality of delivery locations during a particular timeframe and from a single fulfillment location, according to an example embodiment.

FIG. 8 is an example user interface depicting modification of the clustering depicted in FIG. 7.

FIG. 9 is an example user interface depicting an example optional reclustering in response to the modification of the clustering as illustrated in FIG. 8.

FIG. 10 is an example user interface depicting one example route assigned to a given cluster upon arriving at a solution that meets applied constraints, according to one example implementation.

FIG. 11 is a block diagram of an example computing system with which aspects of the present disclosure may be implemented.

### DETAILED DESCRIPTION

As briefly described above, embodiments of the present invention are directed to a clustering and routing platform that applies capacity constraints at individualized routes as part of the process of clustering deliveries into groups. In particular, vehicle capacity, route length, route efficiency/timing, and various other constraints may be used as part of the clustering process to better group delivery locations into routes. Such application of capacity constraints improves the overall routing solution by better utilizing available vehicle capacity and improving the cost minimization for delivery routes. The application of capacity constraints at the time of cluster creation also reduces the need for iteration through suboptimal routing solutions, and reduces the need for ad-hoc modifications to route definitions as might be created using unconstrained clustering processes.

Specifically, the innovation relates to a method of clustering local route deliveries that uses, as a baseline, k-means clustering. This allows initial clusters to be created, and maps to be generated that show local clusters of deliveries that may correlate to local delivery routes. A user interface may be generated that displays the clusters on a map, allowing a user to modify membership among the clusters. The addition of map data for actual distance metrics and additional capacity constraints improves the overall selection of items for local delivery routes. In particular, use of either (1) a minimum and maximum delivery size that correlates to sizes of vehicles, and/or (2) a cubic capacity of a vehicle and weighted capacity contributions of individualized packages allow the methods described herein to more accurately cluster deliveries into a workable solution.

In particular example aspects, the methods and systems described herein account for vehicles (and therefore clusters) of different sizes or capacities. As an initial matter, a number of clusters may be selected based on a number of known vehicles and vehicle capacities that would be scheduled for a predetermined time period (e.g., on a given day). Each vehicle can be assigned a maximum capacity as a hard constraint, as well as a maximum trip length as a hard constraint. Based on the number of vehicles, a number of clusters is assigned, and initial cluster center locations are defined using the k-means algorithm. Clusters may be assigned to vehicles by ordering such that the smallest capacity vehicle will be assigned to a cluster nearest a mixing center, and a largest capacity vehicle will be assigned to a cluster furthest from the mixing center. In doing so, a cost reduction is achieved, because the “stem line” from a fulfillment location to the cluster center will have a reduced average cost per mile.

In still further example aspects, the clustering process described herein will assign individual packages, or deliveries to each cluster. If a single address is set to receive multiple packages, particular postprocessing techniques ensure that both packages remain within the same cluster (and therefore are delivered by the same vehicle), with some balancing performed to ensure any cluster does not exceed its cubic or route capacity, while continuing to minimize cost as part of the clustering process. In observations, such capacity constrained, route constrained clustering using variable size clusters results in an improvement of over 9% relative to the pre-existing algorithms for clustering which do not account for such constraints.

In example aspects, once deliveries are clustered, a sequence of deliveries may be generated to provide an initial solution for a route that may be supplied to a local delivery carrier. The local routes may be improved after initial creation, for example by swapping delivery locations among routes (clusters), or swapping delivery locations within a sequence in the same route. An automatic, trial and error process may perform such swaps, assess overall delivery time, and if the time is reduced, accept the changes to the route. Alternatively, manual adjustment of clusters may be allowed. If no improvement in terms of reduced delivery time is seen, an attempted swap can be rejected. Overall, this additional swap process that is performed after the k-means clustering and map adjustments can provide up to 4 to 5% less distance traveled overall across all clusters for a given mixing center, thereby further improving overall efficiency of the methods described herein.

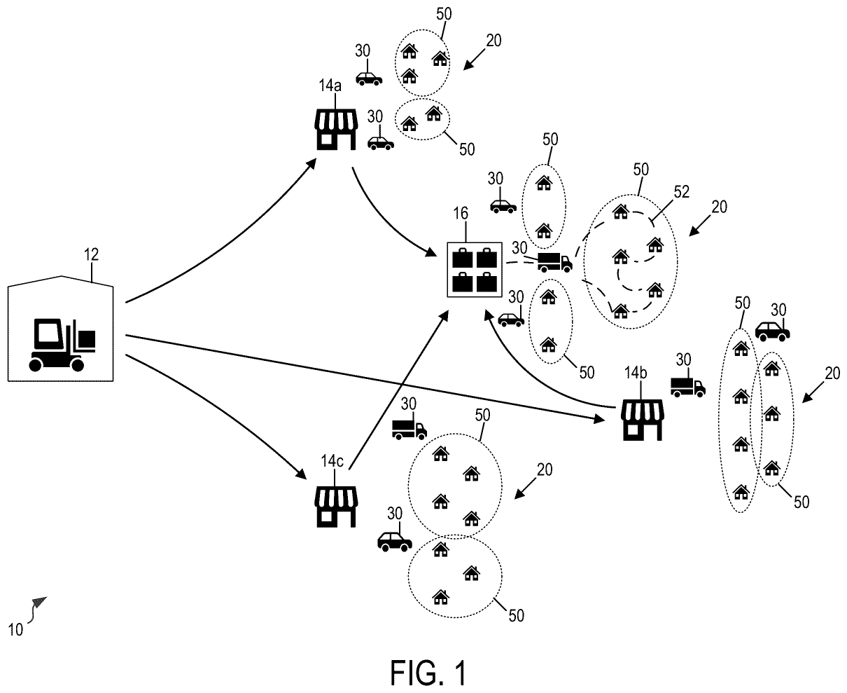

FIG. 1 is an example of a last mile delivery environment 10 in which aspects of the present disclosure may be implemented. Within the last mile delivery environment, one or more warehouses 12 may deliver products to one or more retail locations 14a-c (referred to individually or collectively as a retail location 14). Additionally, each of the retail locations may be requested to supply items for delivery to a downstream transfer point, also referred to as a sortation center 16. Generally speaking, the retail locations 14a-c may be distributed within a geographical area, such as a metro area, and may have different levels of inventory.

The sortation center 16 may receive items from the different retail locations, and consolidate those items for delivery to customer locations, also referred to as delivery locations 20. Additionally, any retail location 14 that has sufficient stock of an item or items that are part of an order for delivery may directly deliver those items to one or more delivery locations 20 that are proximate to the particular retail location 14. Such an arrangement may be provided in different geographical locations, with different numbers of warehouses 12, retail location 14, and sortation centers 16 providing delivery services to delivery locations 20.

From each location at which deliveries may be fulfilled (e.g. stores 14a-c or sortation center 16, and in some instances even warehouse 12), within a particular period of time (e.g. once or twice per day) a set of orders may be collected for delivery, and delivery may be initiated to the delivery locations identified by the orders. The delivery locations may be dispersed within the geographical area, and therefore determining an efficient grouping, or clustering, and routing within a cluster, can dramatically affect delivery efficiency.

Although, in the example shown, separate clustering processes are performed within the same geographical area for each of a plurality of stores 14a-c and a sortation center 16, it is recognized that, in many circumstances, a single clustering process may be performed for a given geographical area that is feasibly served by a single state, such as a sortation center 16. This simplifies the organization and routing of individual carrier vehicles for deliveries, and ensures a single location at which a highest likelihood of available stock can be achieved (e.g. by the sortation center 16 being representative of all stock availability of the stores 14 and warehouse 12 that service the sortation center).

Generally speaking, for a collection of orders that designate delivery locations within a particular period of time, a clustering process may be performed in accordance with aspects of the present disclosure. The clustering process may group delivery locations into clusters 50, with each cluster being representatives of a collection of delivery locations that is able to be serviced by a single delivery vehicle, e.g., delivery vehicles 30 as shown. Notably, within the context of the last mile delivery environment 10, it may often be the case that the delivery vehicles 30 may be of varying size, and therefore may have different capacities for carrying packaged orders, as well as different efficiencies for length of travel. This is particularly the case, for example, in the case of crowd sourced delivery in which third-party vehicles of varying sizes may be utilized to complete such deliveries. Accordingly, as described below, during a clustering process, individual clusters may be created that have size limitations as to the number and type of deliveries that may be added to an individual cluster, dependent upon, e.g., a capacity of the vehicle designated for delivery to that cluster, number of delivery locations and feasibility of delivery to all of the delivery locations within a particular service period, route length, and other similar constraints. Such constraints may be applied on a per cluster basis, as described below.

Once individual clusters are created, routes may be defined for each vehicle within each cluster. For example, a route 52 may be defined for a cluster 50 serviced by a vehicle 30 that delivers items to customer locations 20 from a sortation center 16. The route may be defined based on a shortest distance in accordance with map data, and may be affected by, e.g., weather, traffic, and the like.

In some examples described below, the clustering process used to create clusters 50 may be further modified. For example, clusters may be defined such that larger sized clusters, serviced by larger vehicles, made the biased to be located further away from a fulfillment location, such as sortation center 16 or a store 14, while smaller clusters may be located nearer such fulfillment locations. Such an arrangement may assist with minimization of overall cost, by obtaining the efficiency of a single vehicle traveling a long distance from the fulfillment location to the cluster centroid (generally, the center point of the cluster), thereby averaging down the cost per mile for delivery of items to delivery locations within that cluster. Additionally, smaller vehicles used to deliver items to nearer clusters to be fulfillment location may be able to flexibly adjust their workflows, for example by having a single vehicle perform the required deliveries within multiple such clusters in sequence, if timing allows (e.g., to account for cancellations of other vehicle drivers).

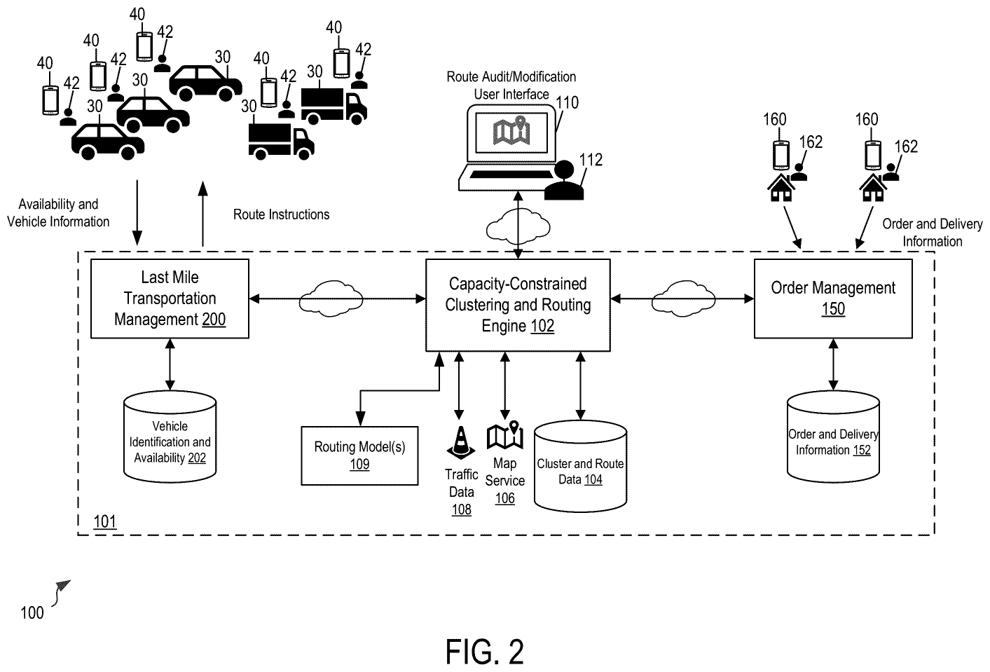

Referring now to FIG. 2, an example block diagram of a system 100 for performing clustering of deliveries in a capacity-constrained environment having variable-capacity delivery mechanisms is provided. The system 100 is implemented, at least in part, on a server platform 101, which may be implemented using one or more computing devices. The system 100 is communicatively interfaced to various user devices 40 of delivery drivers 42 associated with the vehicles 30 described above. Additionally, the system 100 is communicatively interfaced to user devices 160 of users 162 may submit order and delivery information from delivery locations 20. The system 100 includes a capacity constrained clustering and routing engine 102, which is communicatively interfaced to an order management system 150 and a last mile transportation management system 200.

In the example shown, the order management system 150 receives order information from users 162, for example via user devices 160. In example applications, the ordering system 150 receives orders in response to user devices 160 visiting a retail website of a retail organization, and ordering items for delivery to delivery locations associated with those users 162. Order and delivery location information may be stored in a data store 152.

In the example shown, the last mile transportation management system 200 receives driver availability and vehicle information from one or more drivers 42 via user devices 40. The driver availability and vehicle information may include, for example, whether a driver and vehicle are available during a particular timeframe (e.g. a particular day during which deliveries may occur), as well as characteristics of the vehicle, such as vehicle capacity for carrying packaged items for delivery. Other information, for example rates charged by the driver 42, may be provided as well. Such a vehicle identification and availability information may be stored in a data store 202. The last mile transportation management system 200 also will provide route instructions to the drivers 42, e.g., via user devices 40. The user devices 40 may be mobile devices, or may be a computing system associated with a particular carrier contracted to assist with delivery of items to delivery locations.

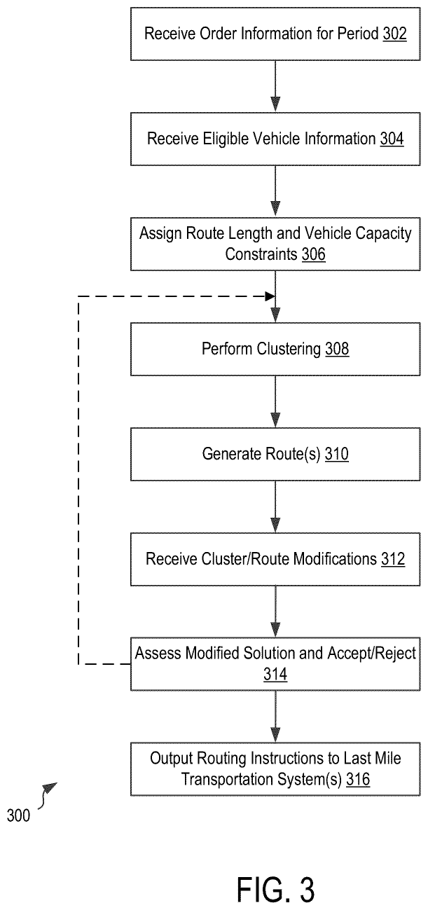

Within the server platform 101, the capacity constrained clustering and routing engine 102 receives the vehicle identification and availability information from the last mile transportation management system 200, as well as the order and delivery information from the order management system 150 to determine a routing solution given the available vehicles during a particular period of time during which delivery is to occur. As described below in conjunction with FIGS. 3-6, a clustering and routing process may be performed at the capacity constrained clustering and routing engine 102 using the received information, as well as information useable to assess an amount of time required to complete deliveries to the delivery locations. This additional information can include, e.g., a map service 106, traffic data 108, and various other information (e.g., weather information and the like). In alternative embodiments, a routing model 109 may be implemented as a machine learning model constructed from past delivery duration data, routing data, weather data, and the like, and which may be used to generate estimated routing times given the locations associated with a particular cluster. Such estimated routing times may be used, for example, to determine whether a set of delivery locations are feasible to complete within a delivery window. The determined cluster and route information may be stored in a database 104.

In some examples, a computing device 110 may be communicatively connected to the server platform 101, and may allow a user 112, for example a logistics manager of the retail organization, to review and modify the created clusters and routes included within the routing solution stored in the database 104. For example, user 112 may view a route audit and modification user interface on the computing device 110 to adjust routes as needed. Additionally, in some other embodiments, the routing solution may be modified automatically using an iterative process to, on a trial and error basis, adjust one or more delivery locations that may be far from a centroid of a cluster into another cluster where such movement does not violate capacity constraints, and reduces overall driving distance. Details of such adjustments are also provided below.

Referring now to FIGS. 3-6, details regarding generation and maintaining a routing solution that is sensitive to capacity constraints of delivery vehicles and delivery routes are provided, for example within a last mile delivery environment. Specifically, FIG. 3 is a flowchart of a method 300 of performing clustering and deployment of delivery routes in a last mile delivery environment, according to an example embodiment. The method 300 may be performed, for example, at a server platform 101, and for example within capacity constrained clustering and routing engine 102 of FIG. 2, described above.

In the example method 300 of FIG. 3, order information for a predetermined period is received (step 302). The order information may include an identification of the items ordered, which may indicate a size or other constraints on the ordered items, as well as a delivery location. Order information may be received from an order management system 150 in response to an online order at a retail website requesting delivery to a particular delivery location, as described above. Size information may be obtained from a database of package sizes that are associated with each order.

In the example shown, the method 300 also includes receiving eligible vehicle information (step 304). The eligible vehicle information may be received from a transportation management system 200, and may include an identification of a number of vehicles available within a predetermined time period (e.g. within a particular day on which a delivery process will occur), as well as constraints associated with the available vehicles.

The method 300 may also include assigning specific constraints to a clustering process based on the vehicle information, as well as one or more other environmental constraints (step 306). Assigning constraints to a clustering process may include, for example, obtaining constraints based on the available vehicles, and assigning those constraints to the expected clusters.

In some examples, vehicle constraints may be defined using an input data set that defines vehicle capacities by package capacity. For example, an input dataset may identify that 11 clusters are desired to be created (e.g., corresponding to 11 available vehicles within a given day or delivery), having a capacity of 30 packages associated with each cluster, as well as 20 clusters (again corresponding to 20 available vehicles) with a capacity of up to 45 packages. Other constraints may include a definition of a maximum of X number of miles per delivery routes, Y number of delivery stops per delivery route, or various other constraints as may be desired to be applied.

In some other examples, rather than capacity in terms of a number of packages, a cubic capacity may be used. For example, a cubic capacity in cubic inches may be defined for a vehicle, and package dimensions may be used, alongside that cubic capacity, in a bin packing problem, to determine a number and type of packages that may fit within a particular vehicle for delivery.

In examples, the capacity constraints determined from vehicles may be applied to clusters in a particular way. For example, assigning constraints to a clustering process can include, for example, obtaining a listing of all available vehicles and constraints, and ordering those vehicles for assignment to the clusters to be created. In examples, the vehicle list may be assigned in order to clusters that are created such that clusters furthest from a fulfillment location are assigned a vehicle having largest capacity.

In example implementations, not only a maximum capacity may be defined, but a minimum capacity may also be defined. While the maximum capacity may be used as a “hard” constraint that cannot be violated, the minimum capacity may be used, in some instances, as a soft constraint on each cluster. Accordingly, the minimum capacity ensures that the clustering algorithm does not place all delivery locations or deliveries within a single cluster, thereby underutilizing other clusters or vehicles within the routing solution overall. Such a solution might otherwise occur where a large number of deliveries are closely-spaced within a geographic area that otherwise has sparsely-distributed deliveries.

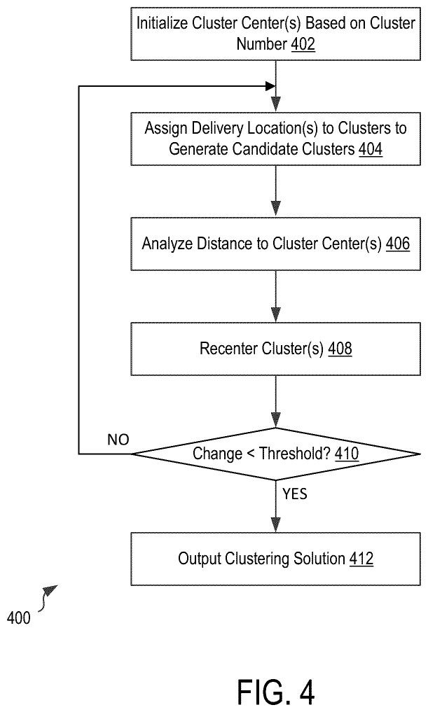

In the example shown, the method 300 further includes performing a clustering process (step 308). In example implementations a k-means clustering process may be used, where a known number of clusters is created within a given geographical area associated with the delivery locations. The known number of clusters, in this case, corresponds to a desired number of vehicles that will be used to deliver items within the predetermined period of time. As described in further detail below, the clustering process involves identifying centroid locations, followed by assigning particular delivery locations to each centroid until the delivery locations are all assigned. Each centroid and associated delivery locations will correspond to a cluster, with the specific number of delivery locations included in a cluster, as well as the total distance among the delivery locations, being constrained by the route length constraints, vehicle capacity constraints, and any other constraints as may be applicable and defined in step 306. An example implementation of this clustering process is provided in greater detail below, in conjunction with FIGS. 4-6.

Once clusters are formed, a route may be generated within each cluster (step 310). The route may generally be defined as a sequence of stops at the delivery locations included within the cluster that would correspond to a minimized travel distance. Route generation may be performed using any of a variety of available mapping, traffic, and other third-party services.

Optionally, the method 300 includes receiving one or more cluster or route modifications (step 312). The modifications may involve, for example, moving a delivery location from being included as a member of one cluster to being included as a member of another cluster adjacent to that cluster. This allows for adjustments where, e.g., two delivery locations are near a cluster border and near each other, but are members of different clusters. From a delivery perspective, it may be more efficient to combine the two delivery locations to a common cluster to minimize travel distance, even if another delivery location would then need to be excluded from the cluster to which the delivery was added to avoid exceeding other capacity constraints. Similarly, in circumstances where the same address may be included within two different clusters (e.g. by being reflected in two different orders) such overlap of addresses may be automatically identified and grouped into a common cluster. Still further, in some cases, manual adjustment of cluster memberships or route definitions may be provided at a user interface, for example by user 112 at computing system 110 described above in conjunction with FIG. 2.

In the example shown, the method 300 further includes assessment of the solution, including any modifications to the solution, relative to be applied constraints and any general goals of the clustering and routing process (step 314). This can include assessment of the clustering constraints to ensure that all constraints are observed and satisfied. Additionally, one or more metrics may be used (e.g. cost per mile for overall deliveries or on a per cluster basis) to compare the solution to other recently generated solutions for other geographic areas, other time periods, and the like. If the solution is found to violate any constraints or be suboptimal in any way, flow may return to the clustering step 308, to perform a re-clustering by, e.g., moving centroids, reassigning particular constraints two different clusters (e.g. adjusting the vehicles assigned to a given cluster), and the like. The clustering and routing process reflected in steps 308, 310, 312 may then be repeated.

In some example implementations, cluster modifications may be made prior to generation of the routes associated with each cluster. However in such circumstances, it may also be advisable to allow for modification of routes after routes are created, since application of relevance within a cluster may subsequently be determined to violate one or more constraints due to, e.g., traffic, weather, detours, and the like.

If the clustering and routing solution is determined to be acceptable, the capacity constrained clustering and routing engine 102 may output the routes to transportation management system 200, for communication with external carriers (e.g. delivery users 42). Such carriers may include a plurality of different carriers across the clusters. The carriers may then ingest delivery instructions and schedule pickup of packages at the designated fulfillment location for delivery in accordance with the designated route. In some instances, carriers may include crowdsourced, third party delivery carriers. The instructions may include delivery windows, including dates/times of pickup of packages, as well as the routing information and delivery addresses.

Referring now to FIG. 4, a flowchart of a method 400 of performing a capacity-constrained clustering process is provided. The method 400 may be used as an example of implementation of the clustering process of step 308 of FIG. 3, above, and may be performed at the capacity constrained clustering and routing engine 102.

In the example shown, the method 400 includes initializing cluster centers based on the number of clusters to the utilized (step 402). The number of clusters to be utilized may correspond, for example, to a number of vehicles available to make deliveries during the particular time period (e.g., a day). Initialization of the cluster centers includes establishing a centroid location at a plurality of locations within a geographic area, with the central location representing a generalized location at a center of an expected cluster. Placement of the centroid may optionally be based on expected capacity of the cluster, with clusters assigned to larger vehicles having centroids positioned further from the fulfillment location as compared to clusters assigned to smaller vehicles.

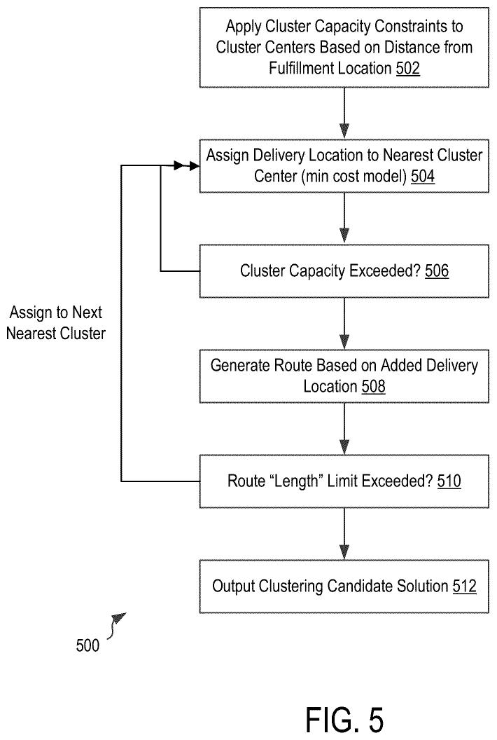

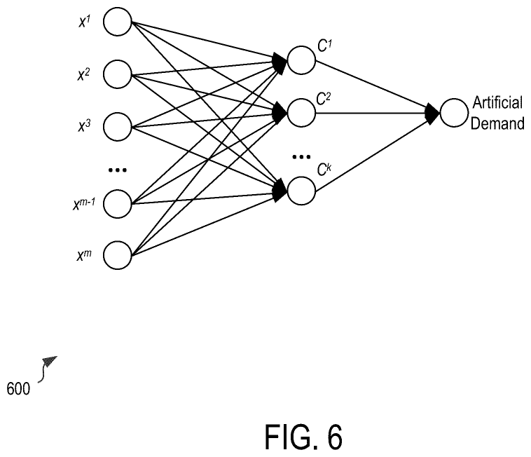

The method 400 further includes assigning delivery locations to clusters to generate candidate clusters (step 404). Assignment of the delivery locations to particular clusters may be performed in accordance with the method described below in conjunction with FIGS. 5-6, for example using a minimum cost flow model. Once delivery locations are assigned to clusters, a distance to the cluster center may be analyzed (step 406). Generally speaking, it can be assumed that, on average, travel distance within a cluster may be similar within similarly sized clusters. However, travel distance to the cluster from a fulfillment location may differ widely, based on the relative locations of the cluster centroid and the fulfillment location.

Accordingly, in the example shown, the method includes re-centering clusters (step 408). Re-centering clusters may include movement of one or more centroid that are used to define locations within the geographic area around which a cluster is centered. The centroids may be moved to accommodate the fact that different clusters will have different capacities, or to otherwise adjust the initial clustering solution. For example, centroids of clusters having too many delivery locations within a cluster, or which are determined to be too inefficient, may be moved closer together, thereby resulting in fewer delivery locations being associated with each cluster. Centroids of clusters into which more deliveries should be encouraged (e.g., clusters below a soft constraint minimum capacity, or which have not yet reached a hard capacity upper limit) may be moved further away from other centroids, thereby creating a larger cluster around that centroid. Such adjustments may be made, for example, to accommodate different sized vehicles. For example, centroids located further away from a fulfillment location (e.g. a sortation center 16 or a retail location 14) may be moved such that they are further away from each other, and may be assigned to a larger capacity vehicle. This encourages use of larger capacity vehicles for longer “stem routes” between the fulfillment location and a centroid of the cluster, which obtains the benefit of lower average per mile cost for that stem portion of a delivery route. Other types of modifications, for example using various adjustment techniques such as genetic algorithms and the like to iteratively experiment with different cluster positioning may be implemented as well.

If the clustering solution, including any changes, falls within a threshold of acceptability, the clustering solution may be output, for example for subsequent routing within each cluster (step 412). However, if the clustering solution is outside a threshold of acceptability, the delivery locations may be re-clustered according to one or more modifications in an attempt to improve overall performance. Example performance metrics may include average per mile cost of delivery, likelihood of delivery success, and the like.

FIG. 5 is a flowchart of a method 500 of generating candidate clusters, in an example implementation. The method 500 may be used, for example, as an implementation of step 404 of method 400 described above, and may be performed at the capacity constrained clustering and routing engine 102.

In the example shown, the method 500 includes applying one or more cluster capacity constraints to each of the cluster centers (step 502). The application of specific cluster capacity constraints may be defined in a variety of ways. For example, cluster constraints may be applied based on a distance from the fulfillment location, with higher capacity clusters being located further from a fulfillment location to obtain the benefit of lower per-mile costs on average by reducing the number of clusters far from the fulfilment location and reducing per mile costs overall for the geographic area due to reduced distance traveled, in the aggregate, between the fulfillment location and cluster centroids. This application of cluster capacity constraints may include assigning a particular capacity to each delivery location corresponding to the volume of goods to be delivered, as well as applying a total capacity available to be allocated to each cluster, given the expected capacity of the vehicle used to deliver to delivery locations within the cluster.

In the example shown, the method includes assigning the delivery locations to a nearest cluster center (step 504). The assignment of delivery locations to a cluster center, and therefore to a cluster, may utilize a minimum cost model modified to incorporate the constraints of road length and capacity as described herein. An example of a minimum cost model usable here is described below in conjunction with FIG. 6.

As delivery locations are assigned to clusters, a cluster capacity assessment may be performed (step 506). The cluster capacity assessment may determine whether the membership of delivery destinations within each of the clusters is outside of the designated minimum and/or maximum cluster capacities. This may be due, for example, to a cluster capacity being exceeded via assignment of a particular delivery location to that cluster. If capacity is exceeded, the delivery location may be reassigned to a next nearest cluster center, again using the minimum cost model. If the cluster capacity is not exceeded, a route may be generated based on the added delivery location (step 508). The route generation may be performed using a mapping tool to define a route among the delivery locations included to that point into a given cluster. Alternatively, a machine learning model may be used to predict the miles per delivery between orders, a transit time estimation based on the give mileage, pickup and dropoff times, and available delivery time to estimate an overall route length.

A route assessment may be performed to determine if the route length limit is exceeded within a given cluster (step 510). The route assessment compares to determined or estimated route length against a route length limit set as a hard constraint. The route length limit may define a longest acceptable route length to complete delivery for a given cluster. This may be varied according to the specific carrier or vehicle, to meet customer expectations, or based on a type of item to be delivered (e.g., perishable or non-perishable goods). If the route length limit is exceeded, the delivery location may also then be reassigned to another cluster, such as a next nearest cluster, and cluster capacity and route length constraints may be reassessed thereafter. If cluster capacity and route length limits are not exceeded, and other constraints are generally met, the location assignment may be acceptable. One or more soft constraints, such as minimum cluster sizes, may again be assessed in this instance, with modifications made to cluster memberships to balance delivery locations across clusters.

Generally, speaking, the cluster assignment may be performed for each delivery location individually, or concurrently, using the minimum cost model. Constraint assessments (e.g., for capacity, route length, and the like) may be performed after each delivery location assignment, or after more than one such assignment (e.g., after all assignments). Once all delivery locations are associated with clusters, a clustering candidate solution may be output (step 512) for downstream assessment in accordance with the iteration and constraint assessment steps described above, and ultimately for communication to a transportation management system, such as system 200.

FIG. 6 is a logical diagram of a minimum cost flow portion of a clustering algorithm used in conjunction with aspects of the present disclosure. The minimum cost flow problem described below may be used to assign delivery locations to clusters, for example as described above in conjunction with step 504 of FIG. 5.

Generally speaking, diagram 600 depicts a plurality of delivery nodes x, assigned to clusters C. from each delivery node, there is a directed arc to each cluster (shown by arrows). This means that any delivery location, or node, may be assigned to each cluster. Each arc has a capacity which can be set at a volume (e.g., a cubic volume) assigned to that delivery location. Additionally, an artificial demand mode is depicted, which is used to ensure that a balance of total supply and demand in the problem set is maintained.

In the clustering process, a particular additional variable xᵢⱼ is provided, to address the possibility of split orders. That is, the clustering process performed is considered an “unsplittable” minimum cost flow problem. The process involves a bin packing process in which each package has a different cubic volume. A standard minimum cost flow solution may be used, followed by heuristics used to swap individual delivery locations to ensure no orders are split, such that two orders at the same delivery location are assigned to be members of different clusters, while maintaining capacity constraints.

A minimum cost flow problem can generally be defined as being performed to cluster a set of nodes N into clusters C. Each node with a value b indicates whether that node is a supply node (bᵢ>0), a demand node (bᵢ<0), or a transshipment node (bᵢ=0). A represents a set of directed arcs among the nodes. For each arc (i,j) within the set A, the variable cy corresponds to a cost of flow of goods between the two nodes, and can be defined to include a distance between the cluster center and delivery location in the clustering problem. A variable ƒᵢⱼ indicates a flow of arcs, and corresponds to a cubic capacity of the delivery node that is assigned to the cluster center in the clustering problem. The variable xᵢⱼ is added to ensure that there is no split of flow of the delivery nodes. Accordingly, the minimum cost flow problem may be depicted as follows:

$$min {\sum }_{( i , j ) ∈ A} {e}_{ij} {f}_{ij} {x}_{ij} \qquad ( 1 )$$

$${\sum }_{i} {f}_{ij} {x}_{ij} - {\sum }_{j} {f}_{ji} {x}_{ji} = \sum {b}_{i} ∀ i ∈ N \qquad ( 2 )$$

$${\sum }_{j} {x}_{ij} = 1 \qquad ( 3 )$$

$$0 \leq {f}_{ij} \leq {u}_{ij} \qquad ( 4 )$$

$${x}_{ij} = ( 0 , 1 ) \qquad ( 5 )$$

In the above, Equation (1) is an objective function that minimizes the total distance to cluster centers from each delivery point, Equation (2) represents a balance constraint to ensure that incoming and outgoing flow of a node is equal to b, Equation 3 ensures flow is not split, such that each delivery node is assigned to a unique cluster, Equation 4 ensures that flow of an arc is less than or equal to a capacity of the cluster, and Equation 5 shows that xᵢⱼ is either 1 or 0, meaning that an arc is either chosen, or it is not.

In accordance with the minimum cost flow process described above, deliveries, and therefore delivery locations, are assigned to clusters according to a minimized cost arc associating the delivery to the cluster, with the cost representing flow of goods being able to accommodate costs of flowing goods to the destination. By defining cost of delivery as including, e.g., capacity, mileage, and the like, and using individual cost assignments for each delivery node, individual weighting may be introduced into the clustering process.

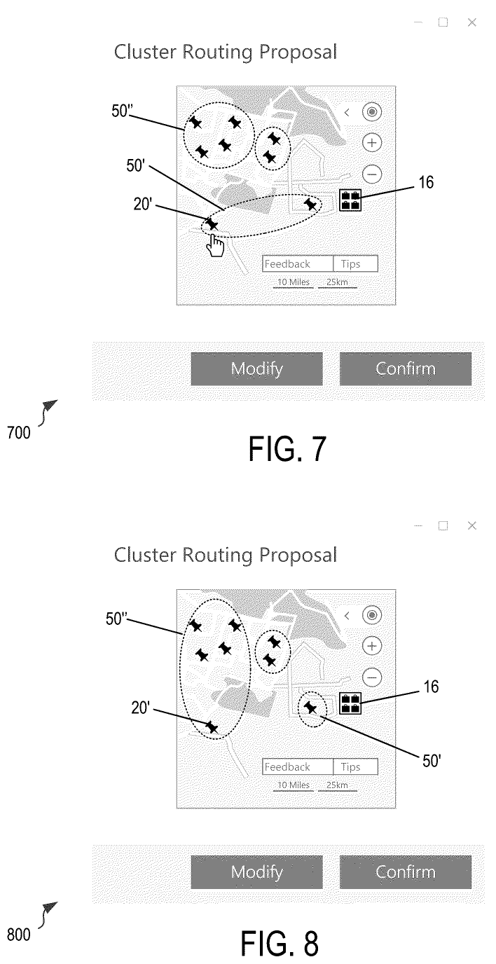

Referring now to FIGS. 7-10, example user interfaces that may be generated at a capacity constrained clustering and routing engine 102 and displayed at a computing system 110 to a user 112 are provided. The user interfaces allow user 112 to view and optionally modify clustering and routing solutions generated using the methods and systems described herein to improve overall solution efficiency.

FIG. 7 illustrates a first example user interface 700 depicting a set of clusters 50 associated with a plurality of delivery locations 20 within a predetermined timeframe, and form a single fulfillment location, e.g., a sortation center 16. In the example user interface 700, three separate clusters are illustrated. This may be the result of generation of a candidate clustering solution using three available vehicles having different capacities and/or route lengths. In this example, a user input indicator 702 may select one or more delivery locations 20, e.g., delivery location 20′, to add that delivery location to another cluster (e.g., to move from cluster 50′ to cluster 50″).

In response to movement of delivery location 20′ between clusters, a revised clustering solution may be generated, as seen in the user interface 800 of FIG. 8. In this example, cluster 50″ now includes the delivery location 20′. Notably, this may be allowed in the event that it may reduce overall distance traveled, and does not exceed other capacity constraints, such as route length or capacity associated with cluster 50″. In this instance, cluster 50′ may fall below a soft constraint of a minimum capacity. In such a case, the movement of delivery location 20′ among the clusters might be rejected, even if it results in a slight reduction in overall cost of deliveries.

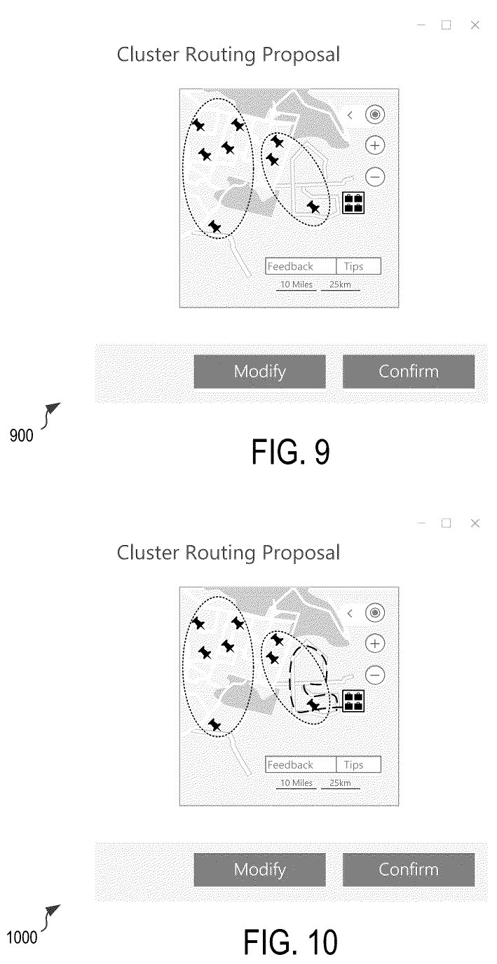

In some instances, a reclustering process may be performed in which different sets or numbers of clusters may be performed. For example, as seen in the user interface 900 FIG. 9, by changing from three to two cluster centroids, and moving those centroids, a revised solution may be generated. As above, the delivery locations associated with each cluster may be modified between the clusters, either manually or automatically, to reduce overall distance and therefore overall cost, after routing for each cluster is determined. As illustrated in FIG. 10, a user interface 1000 may present both a clustering and a routing solution to a user in some examples, for one or more (e.g., all) clusters. Accordingly, the user (e.g., user 112) may see the routing proposed for the given delivery locations in the cluster to selectively adjust association of the delivery locations to the various clusters.

Referring to FIGS. 1-10 generally, the capacity-constrained clustering and routing processes provided herein have a number of advantages over existing solutions. In particular, by individually assigning constraints to each cluster, the capacity of each available vehicle may be more efficiently accounted for and used. Furthermore, by allowing manual modification or automated test-and-repeat modifications of clustering and routing solutions, modifications to clustering solutions may be made while remaining within the hard and optionally soft constraints defined as part of the solution.

Although in some instances, the individual application of per-cluster constraints may add additional computational complexity to the clustering and routing processes involved, the improved efficiency achieved in terms of resulting fewer iterations through otherwise-unworkable routing solutions increases the overall computational efficiency of the solution. In particular, prior solutions would require re-assessment if a particular order is returned as infeasible due to vehicle size or route length, leading to significant run time delay and solution revisions, which are avoided by the current computational approach which reduces such errors.

The current approach also experimentally is seen to improve efficiency in routing. In some specific examples, the above approaches were applied in a last mile delivery simulation, using 21 days of sample delivery data and an average of 5,500 to 8,500 deliveries within a particular geographical area on a day. A random assignment of an assortment of delivery vehicles having a capacity of 25-35 packages per vehicle was made, and the above approach was compared against previous constraint-agnostic approaches. While a previous approach resulted in an end effect of 1.24 miles per delivery (mpd), the above simulated approach resulted in 1.135 miles per delivery, or over 9% reduction in miles traveled between deliveries, with a resultant reduction in cost.

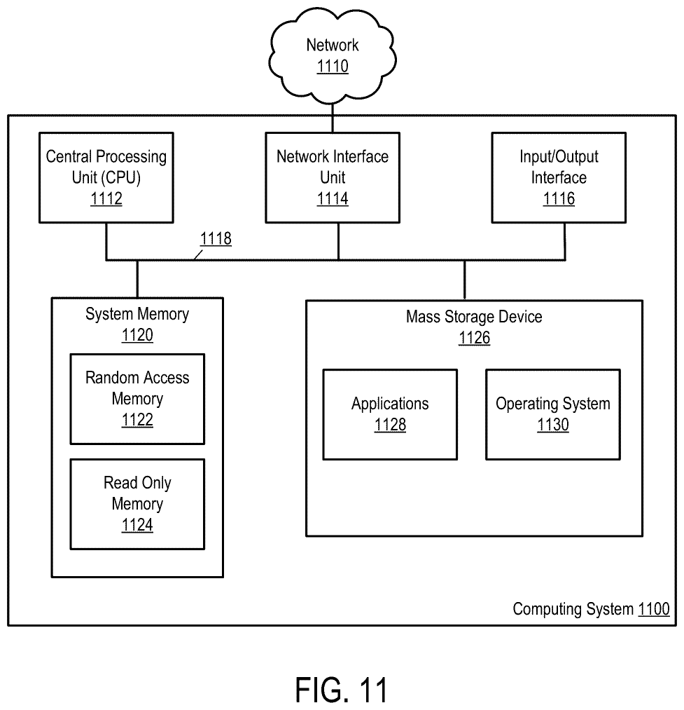

FIG. 11 is a block diagram of an example computing system 1100 with which aspects of the present disclosure may be implemented. The example computing system 1100 may be used alone or in combination with other similar devices to implement the server platform or systems included therein, or various other computing devices as described above. In the embodiment shown, the computing system 1100 includes at least one central processing unit (“CPU”) 1112, a system memory 1120, and a system bus 1118 that couples the system memory 1120 to the CPU 1112. The system memory 1120 includes a random access memory (“RAM”) 1122 and a read-only memory (“ROM”) 1124. A basic input/output system that contains the basic routines that help to transfer information between elements within the computing system 1100, such as during startup, is stored in the ROM 1124. The computing system 1100 further includes a mass storage device 1126. The mass storage device 1126 is able to store software instructions and data.

The mass storage device 1126 is connected to the CPU 1112 through a mass storage controller (not shown) connected to the system bus 1118. The mass storage device 1126 and its associated computer-readable storage media provide non-volatile, non-transitory data storage for the computing system 1100. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 1112 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 1100.

According to various embodiments of the invention, the computing system 1100 may operate in a networked environment using logical connections to remote network devices through a network 1110, such as a wireless network, the Internet, or another type of network. The computing system 1100 may connect to the network 1110 through a network interface unit 1114 connected to the system bus 1118. It should be appreciated that the network interface unit 1114 may also be utilized to connect to other types of networks and remote computing systems. The computing system 1100 also includes an input/output controller 1116 for receiving and processing input from a number of other devices, including a touch user interface display screen, or another type of input device. Similarly, the input/output controller 1116 may provide output to a touch user interface display screen or other type of output device.

As mentioned briefly above, the mass storage device 1126 and the RAM 1122 of the computing system 1100 can store software instructions and data. The software instructions include an operating system 1130 suitable for controlling the operation of the computing system 1100. The mass storage device 1126 and/or the RAM 1122 also store software instructions 1128, that when executed by the CPU 1112, cause the computing system 1100 to provide the functionality discussed in this document. For example, the mass storage device 1126 and/or the RAM 1122 can store software instructions that, when executed by the CPU 1112, cause the computing system 1100 to provide a capacity constrained clustering and routing management system as described herein.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of a last mile delivery routing solution, technologies disclosed herein are applicable to order processing and transportation logistics technologies generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method of generating a routing solution for last-mile deliveries of items to customers, the method comprising:
receiving, at a computing system, order information regarding a plurality of orders of items for delivery to different delivery locations within a geographical area;
receiving, at the computing system, an identification of a plurality of vehicles eligible to perform deliveries within the geographical area within a predetermined delivery time period;
assigning, at the computing system, a maximum route length and a maximum delivery capacity to each of the plurality of vehicles, wherein the maximum delivery capacity varies among the plurality of vehicles;
based on a determined size of each of the plurality of orders, the different delivery locations, the maximum route length, and the maximum delivery capacity of each of the plurality of vehicles, performing, at the computing system, a clustering algorithm on the plurality of orders to generate a plurality of clusters, each cluster being associated with a different, particular vehicle of the plurality of vehicles and including a plurality of delivery locations that are associated with one of the plurality of orders; and
for each cluster, generating a route among the plurality of delivery locations assigned to the cluster, the route being assigned to the particular vehicle such that the orders associated with the plurality of delivery locations do not exceed the maximum delivery capacity of the particular vehicle and the route has a length less than the maximum route length.

2. The method of claim 1, further comprising generating a display, via the computing system, of at least one route associated with a corresponding at least one cluster, the at least one route corresponding to a sequence of deliveries to each of the plurality of delivery locations assigned to the cluster.

3. The method of claim 1, further comprising displaying, on a user interface, the plurality of clusters.

4. The method of claim 3, further comprising displaying, on the user interface, an initial route among the delivery locations associated with a cluster.

5. The method of claim 4, further comprising receiving, at the user interface, a modification of one or more routes by reassigning a delivery location from a first route to a second route.

6. The method of claim 5, further comprising automatically assigning a second delivery location from the second route to a different route in response to reassigning the delivery location to the second route.

7. The method of claim 6, wherein the different route is determined based on a maximum route length, a maximum delivery capacity, a current route length, and a current available delivery capacity of a vehicle assigned to one or more neighboring routes to the second route.

8. The method of claim 7, wherein the different route comprises the first route.

9. The method of claim 1, wherein the clustering algorithm comprises a k-means clustering algorithm.

10. The method of claim 1, wherein the clustering algorithm minimizes a cost of delivery to each cluster based on the route length.

11. The method of claim 1, wherein the maximum delivery capacity comprises a cubic volume available for carrying items associated with orders for a vehicle of the plurality of vehicles.

12. The method of claim 1, wherein the plurality of clusters includes at least a first cluster and a second cluster, the first cluster being nearer a fulfillment location than the second cluster, and wherein a maximum delivery capacity associated with a particular vehicle assigned to the first cluster is smaller than a maximum delivery capacity associated with a different particular vehicle assigned to the second cluster.

13. A delivery routing system implemented on at least one computing device, the delivery routing system comprising:
a processor;
a memory storing computer-executable instructions which, when executed, cause the delivery routing system to perform:
receiving, at a computing system, order information regarding a plurality of orders of items for delivery to different delivery locations within a geographical area;
receiving, at the computing system, an identification of a plurality of vehicles eligible to perform deliveries within the geographical area within a predetermined delivery time period;
assigning, at the computing system, a maximum route length and a maximum delivery capacity to each of the plurality of vehicles, wherein the maximum delivery capacity varies among the plurality of vehicles;
based on a determined size of each of the plurality of orders, the different delivery locations, the maximum route length, and the maximum delivery capacity of each of the plurality of vehicles, performing, at the computing system, a clustering algorithm on the plurality of orders to generate a plurality of clusters, each cluster being associated with a different, particular vehicle of the plurality of vehicles and including a plurality of delivery locations that are associated with one of the plurality of orders; and
for each cluster, generating a route among the plurality of delivery locations assigned to the cluster, the route being assigned to the particular vehicle such that the orders associated with the plurality of delivery locations do not exceed the maximum delivery capacity of the particular vehicle and the route has a length less than the maximum route length.

14. The system of claim 13, further comprising a routing database stored in the memory, the routing database storing a plurality of routes associated with each of the plurality of clusters.

15. The system of claim 13, further comprising a user interface displayable on a user device operatively connected to the at least one computing device, the user interface displaying at least one route associated with a corresponding at least one cluster, the at least one route corresponding to a sequence of deliveries to each of the plurality of delivery locations assigned to the cluster.

16. The system of claim 15, wherein the user interface is configured to display the plurality of clusters and an initial route among the delivery locations associated with a cluster from among the plurality of clusters.

17. The system of claim 16, wherein the user interface is configured to receive a modification of one or more routes reassigning a delivery location from a first route to a second route.

18. The system of claim 13, wherein performing the clustering algorithm includes executing an unsplittable minimum cost flow optimization process to generate the plurality of clusters.

19. The system of claim 13, wherein the plurality of clusters includes at least a first cluster and a second cluster, the first cluster being nearer a fulfillment location than the second cluster, and wherein a maximum delivery capacity associated with a particular vehicle assigned to the first cluster is smaller than a maximum delivery capacity associated with a different particular vehicle assigned to the second cluster.

20. A computer storage medium storing computer-executable instructions thereon which, when executed by a computing system including a processor and a memory, cause the computing system to perform a method of generating a routing solution for last-mile deliveries of items to customers, the method comprising:
receiving, at a computing system, order information regarding a plurality of orders of items for delivery to different delivery locations within a geographical area;
receiving, at the computing system, an identification of a plurality of vehicles eligible to perform deliveries within the geographical area within a predetermined delivery time period;
assigning, at the computing system, a maximum route length and a maximum delivery capacity to each of the plurality of vehicles, wherein the maximum delivery capacity varies among the plurality of vehicles;
based on a determined size of each of the plurality of orders, the different delivery locations, the maximum route length, and the maximum delivery capacity of each of the plurality of vehicles, performing, at the computing system, a clustering algorithm on the plurality of orders to generate a plurality of clusters, each cluster being associated with a different, particular vehicle of the plurality of vehicles and including a plurality of delivery locations that are associated with one of the plurality of orders; and
for each cluster, generating a route among the plurality of delivery locations assigned to the cluster, the route being assigned to the particular vehicle such that the orders associated with the plurality of delivery locations do not exceed the maximum delivery capacity of the particular vehicle and the route has a length less than the maximum route length.
